(19) United States
(12) Patent Application Publication
(10) Pub. No.: US 2025/0300859 A1
(43) Pub. Date: Sep. 25, 2025

(54) CHANNEL RECIPROCITY TRANSFORM FOR MULTIPLE FREQUENCY BEAM-FORMING

(71) Applicant: Telefonaktiebolage LM Ericsson (publ), Stockholm (SE)

(72) Inventors: Pierre-Andre LAPORTE, GATINEAU ,Quebec (CA); Mark WYVILLE, OTTAWA, Ontario (CA)

(73) Assignee: Telefonaktiebolage LM Ericsson (publ), Stockholm (SE)

(21) Appl. No.: 18/864,549

(22) PCT Filed: Jun. 14, 2022
(86) PCT No.: PCT/IB2022/055510

§ 371 Date: Nov. 11, 2024

(51) Int. Cl. H04L 25/02; H04B 7/06; H04L 5/00; H04L 27/26

(52) U.S. Cl. CPC H04L 25/022; H04B 7/0617; H04L 5/0007; H04L 27/2628

(57) ABSTRACT

A method and network node for implementing a channel reciprocity transform for multiple frequency beamforming are disclosed. According to some aspects, a method in a network node includes determining an average angular spectral density (ASD) based at least in part on a Fast Fourier transform (FFT) of an uplink received vector for each of multiple subcarriers from at least one antenna polarization. The method includes resampling the average ASD at a wavelength for a subcarrier of the multiple subcarriers in a downlink sub-band. The method also includes determining a frequency-transposed channel estimate for the downlink sub-band based at least in part on an inverse Fast Fourier transform (IFFT) of the resampled average ASD. The method also includes beamforming a signal to the WD in the downlink sub-band using the determined frequency-transposed channel estimate.

### TECHNICAL FIELD

The present disclosure relates to wireless communications, and in particular, to a channel reciprocity transform for multiple frequency beamforming.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

In cellular networks, the downlink carriers can be paired with uplink channels that are located at a different frequency such as in Frequency Division Duplex (FDD) or as in Carrier Aggregation (CA) scenarios. In those situations, the downlink tends to rely on codebook-based transmissions which can lead to non-optimal network performance. Indeed, the channel response is rather coarsely quantized in codebook transmissions and there is also some latency introduced by the feedback loops from the wireless devices (WDs), such that the updated Precoding Matrix Indices (PMI's) only become available at the base station after some time.

The throughput loss associated with codebook-based transmissions, compared to that of reciprocity-based systems, is more pronounced when the WDs are stationary or slowly moving.

High-capacity downlink multiple user multiple input multiple output (MU-MIMO) solutions for dense urban environments can be enabled in codebook-based systems by sending more information about the channel as in the NR Type-II channel state information reference signal (CSI-RS) feedback. However, this is achieved at the cost of more signaling overhead in the uplink. Beamforming solutions relying on Type-II CSI-RS feedback can also suffer from uplink control information (UCI) coverage limitations, thus limiting their potential deployment scenarios.

Algorithms have been proposed in the academic literature to address the so-called multiple frequency channel reciprocity problem:
In one known method, a transformation for the spatial correlation is derived taking imperfections in the antenna array and modelling errors into account. The transformation is defined as a convex optimization problem and solved using the interior point method;
In another known method, two algorithms are presented. The first one exploits similarity in the spatial-temporal correlation between the uplink and downlink frequencies and introduces a dilating factor by interpolation via cubic splines. The second algorithm requires knowledge of the user velocity;
In another known method, a spatial basis expansion model (SBEM) is presented. The uplink signal is processed using a spatial discrete Fourier transform (DFT), only retaining the very few fast Fourier transform (FFT) bins containing greater than 95% of the signal's power;
In another known method, a deep neural network is used to map the channel in space and frequency.

Some of these solution suffer from high complexity and at least one of these solutions suffers from low resolution and degraded performance in rich scattering environments.

### SUMMARY

Some embodiments advantageously provide methods and network nodes for implementing a channel reciprocity transform for multiple frequency beamforming.

In some embodiments, a high-resolution multiple frequency channel reciprocity transform is employed, thus enabling reciprocity-based downlink single user (SU)-MIMO and MU-MIMO in FDD as well as in carrier aggregation scenarios. This transform may also be used to acquire the downlink passive intermodulation (PIM) subspace for downlink PIM spatial avoidance algorithms.

In some embodiments, an oversampled DFT processes the signal from multiple physical uplink channels, thus decoupling the channel estimation refresh rate from the sounding reference signal (SRS) periodicity. The average angular spectral density (ASD) is then resampled at the wavelength corresponding to one or more downlink sub-bands. This provides high resolution and high-fidelity downlink information about the instantaneous wideband channel behavior.

Some embodiments have one or more of the following advantages:
1) Good channel tracking ability as multiple physical uplink channels can be fed into the algorithm (physical uplink control channel (PUCCH), physical uplink shared channel (PUSCH), SRS, demodulation reference signal (DMRS)), thus increasing channel estimation robustness. This also helps decoupling the channel estimation refresh rate from the SRS periodicity;
2) Low signaling overhead;
3) High spatial resolution;
4) Insensitive to UCI coverage;
5) Moderate computational cost;
6) Enables reciprocity-based downlink SU-MIMO and MU-MIMO in FDD as well as in carrier aggregation scenarios; and/or
7) Can be used for the downlink PIM subspace acquisition.

According to some aspects, a method in network node includes determining an average angular spectral density, ASD, based at least in part on a Fast Fourier transform, FFT, of an uplink received vector for each of multiple subcarriers from at least one antenna polarization. The method also includes resampling the average ASD at a wavelength for a subcarrier of the multiple subcarriers in a downlink sub-band. The method includes determining a frequency-transposed channel estimate for the downlink sub-band based at least in part on an inverse Fast Fourier transform, IFFT, of the resampled average ASD. The method further includes beamforming a signal to the WD in the downlink sub-band using the determined frequency-transposed channel estimate.

In some embodiments, the process also includes adding zeros to an input to the FFT to increase resolution of the average ASD. In some embodiments, determining the average ASD includes frequency-domain averaging ASDs for multiple subcarriers that belong to a same orthogonal frequency division multiplexed, OFDM, symbol. In some embodiments, determining the average ASD includes time-domain averaging a frequency-domain averaged ASD. In some embodiments, the time-domain averaging includes multiplying the frequency-domain averaged ASDs by one of a moving average and exponential decay function to forget past snapshots and offer good channel tracking performance in fast fading conditions. In some embodiments, the process also includes, prior to resampling the average ASD, frequency-shifting the average ASD so that a DC component of the average ASD is located in a center of a spectrum of the average ASD. In some embodiments, resampling the average ASD includes interpolating the average ASD using at least one of linear, polynomial and spline interpolation. In some embodiments, complex valued ASD data is interpolated using one of cartesian or polar coordinates. In some embodiments, the method also includes multiplying the resampled average ASD by a windowing function prior to determining the IFFT. In some embodiments, the method further includes frequency-shifting the average ASD to an initial state, so that a DC component is located at a first IFFT entry point prior to determining the IFFT. In some embodiments, the method also includes complex-conjugating an output of the IFFT to model an effect of an uplink channel covariance matrix transpose operation. In some embodiments, a first N entries from an output of the IFFT are retained, the first N entries corresponding to the frequency-transposed channel estimate, with remaining entries of the IFFT output corresponding to an initial zero padding being discarded. In some embodiments, the ASD is based at least in part on multiple uplink physical channels. In some embodiments, determining the average ASD includes determining an ASD based at least in part on uplink eigenvectors. In some embodiments, the uplink eigenvectors are uplink passive intermodulation, PIM, eigenvectors. In some embodiments, the frequency-transposed downlink channel estimate is used to reduce the downlink power in the direction of external PIM sources.

According to another aspect, a network node configured to communicate with a wireless device, WD. The network node includes processing circuitry configured to: determine an average angular spectral density, ASD, based at least in part on a fast Fourier transform, FFT, of an uplink received vector for each of multiple subcarriers from at least one antenna polarization. The processing circuitry is further configured to resample the average ASD at a wavelength for a subcarrier of the multiple subcarriers in a downlink sub-band. The processing circuitry is further configured to determine a frequency-transposed channel estimate for the downlink sub-band based at least in part on an inverse fast Fourier transform, IFFT, of the resampled average ASD. The processing circuitry is further configured to beamform a signal to the WD in the downlink sub-band using the determined frequency-transposed channel estimate.

According to this aspect, in some embodiments, the processing circuitry is further configured to add zeros to an input to the DFT to increase resolution of the average ASD. In some embodiments, determining the average ASD includes frequency-domain averaging ASDs for each of the multiple subcarriers that belong to a same orthogonal frequency division multiplexed, OFDM, symbol. In some embodiments, determining the average ASD includes time-domain averaging a frequency-domain averaged ASD. In some embodiments, the time-domain averaging includes multiplying the frequency-domain averaged ASDs by one of a moving average and exponential decay function to forget past snapshots and offer good channel tracking performance in fast fading conditions. In some embodiments, the processing circuitry is further configured to, prior to resampling the average ASD, frequency-shift the average ASD so that a DC component of the average ASD is located in a center of a spectrum of the average ASD. In some embodiments, resampling the average ASD includes interpolating the average ASD using at least one of linear, polynomial and spline interpolation. In some embodiments, complex valued ASD data is interpolated using one of cartesian and polar coordinates. In some embodiments, the processing circuitry is further configured to multiply the resampled average ASD by a windowing function prior to determining the IFFT. In some embodiments, the processing circuitry is further configured to frequency-shift the average ASD to an initial state, so that a DC component is located at a first IFFT entry point prior to determining the IFFT. In some embodiments, the processing circuitry is further configured to complex-conjugate an output of the IFFT to model an effect of an uplink channel covariance matrix transpose operation. In some embodiments, a first N entries from an output of the IFFT are retained, the first N entries corresponding to the frequency-transposed channel estimate, with remaining entries of the IFFT output corresponding to an initial zero padding being discarded. In some embodiments, the ASD is based at least in part on multiple uplink physical channels. In some embodiments, determining the average ASD includes determining an ASD based at least in part on uplink eigenvectors. In some embodiments, the uplink eigenvectors are uplink passive intermodulation, PIM, eigenvectors. In some embodiments, the frequency-transposed downlink channel estimate is used to reduce the downlink power in the direction of external PIM sources.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for a channel reciprocity transform for multiple frequency beamforming;

FIG. 8 is a block diagram of an embodiment for channel reciprocity transformation according to principles disclosed herein;

FIG. 9 is a block diagram of another embodiment for channel reciprocity transformation according to principles disclosed herein; and

FIG. 10 is graph of algorithm complexity for a known method and for a method disclosed herein for channel reciprocity transformation.

### DETAILED DESCRIPTION

Before describing in detail example embodiments, it is noted that the embodiments reside primarily in combinations of apparatus components and processing steps related to a channel reciprocity transform for multiple frequency beamforming. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide a channel reciprocity transform for multiple frequency beamforming.

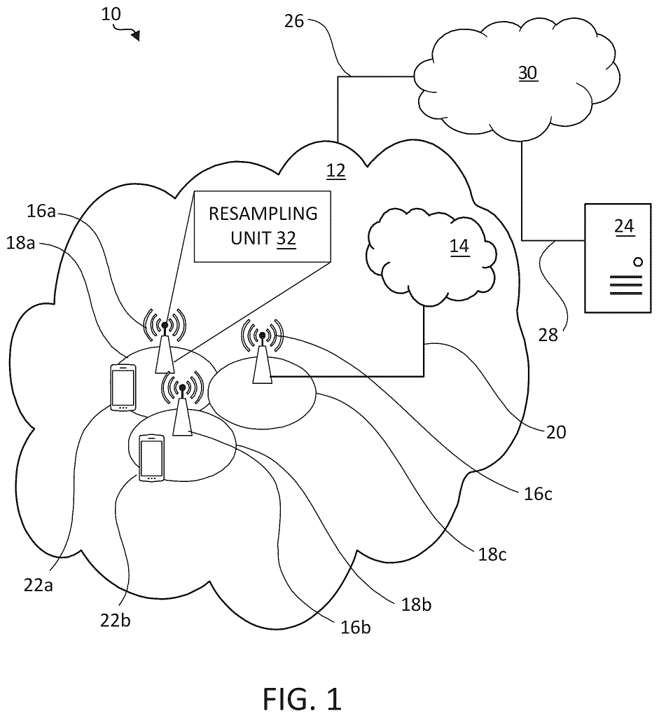

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a resampling unit 32 which is configured to resample the average ASD at a wavelength for a subcarrier of the multiple subcarriers in a downlink sub-band.

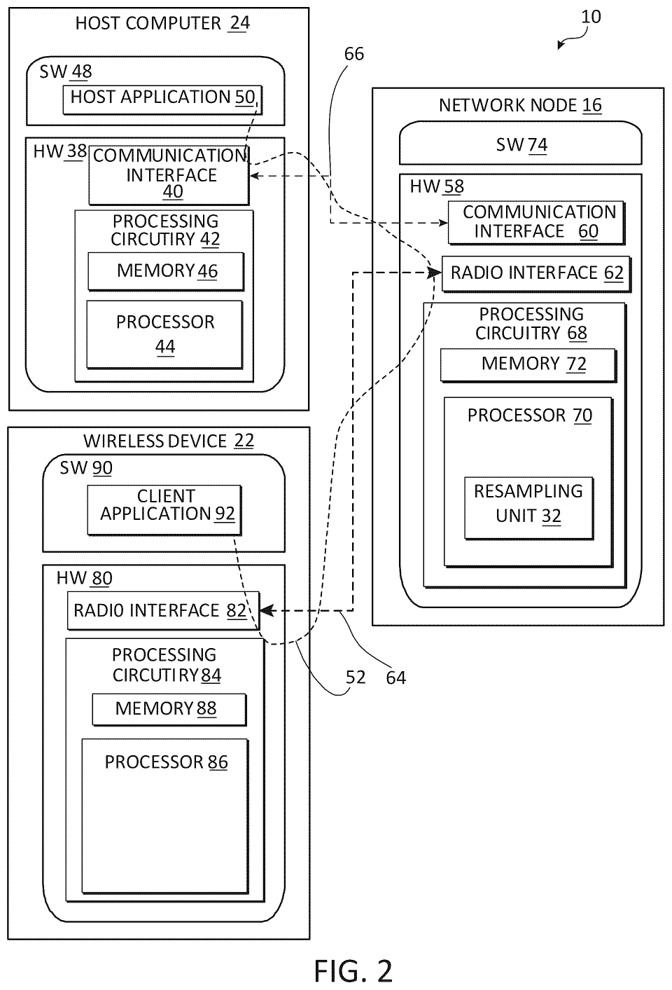

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a resampling unit 32 which is configured to resample the average ASD at a wavelength for a subcarrier of the multiple subcarriers in a downlink sub-band.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as resampling unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

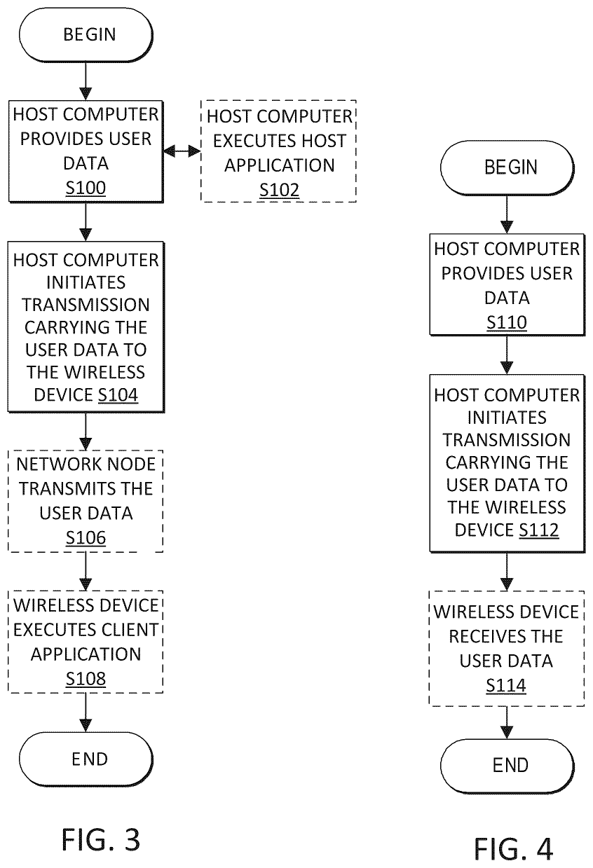

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

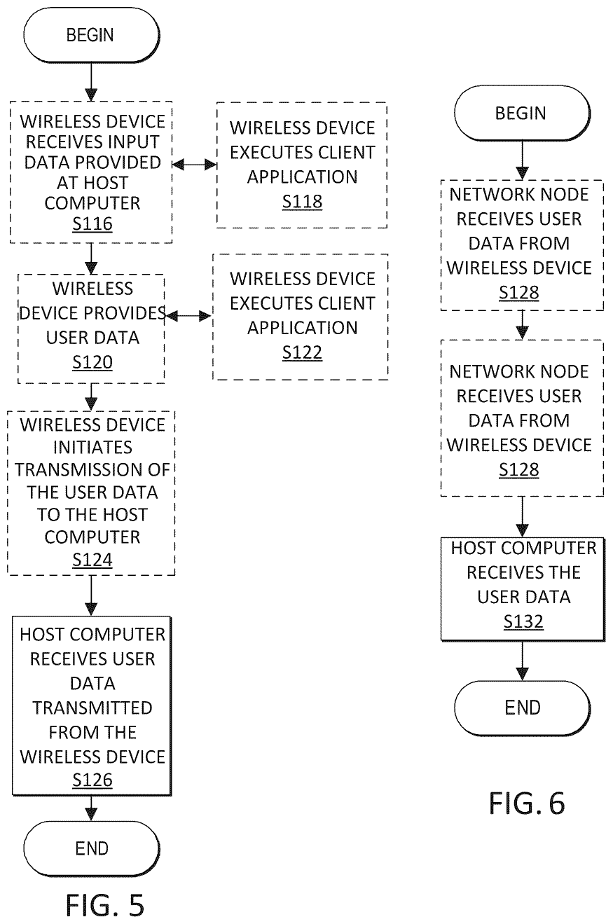

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

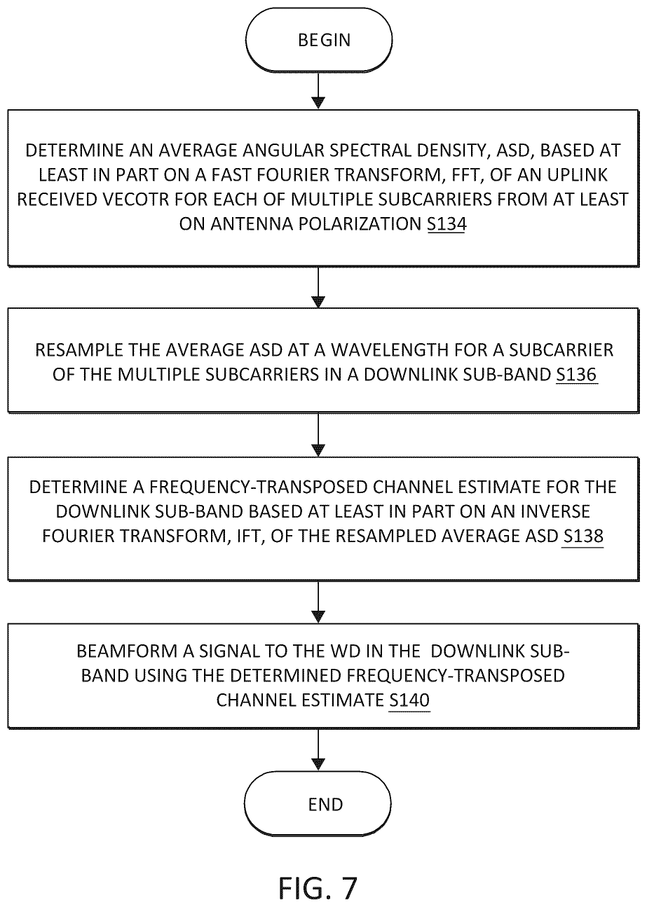

FIG. 7 is a flowchart of an example process in a network node 16 for a channel reciprocity transform for multiple frequency beamforming. One or more blocks described herein may be performed by one or more elements of network node 16 such as by one or more of processing circuitry 68 (including the resampling unit 32), processor 70, radio interface 62 and/or communication interface 60. Network node 16 such as via processing circuitry 68 and/or processor 70 and/or radio interface 62 and/or communication interface 60 is configured to determine an average angular spectral density, ASD, based at least in part on a Fast Fourier transform, FFT, of an uplink received vector for each of multiple subcarriers from at least one antenna polarization (Block S134). The process also includes resampling the average ASD at a wavelength for a subcarrier of the multiple subcarriers in a downlink sub-band (S136). The process includes determining a frequency-transposed channel estimate for the downlink sub-band based at least in part on an inverse Fast Fourier transform, IFFT, of the resampled average ASD (Block S138). The process further includes beamforming a signal to the WD in the downlink sub-band using the determined frequency-transposed channel estimate (Block S140).

In some embodiments, the process also includes adding zeros to an input to the FFT to increase resolution of the average ASD. In some embodiments, determining the average ASD includes frequency-domain averaging ASDs for multiple subcarriers that belong to a same orthogonal frequency division multiplexed, OFDM, symbol. In some embodiments, determining the average ASD includes time-domain averaging a frequency-domain averaged ASD. In some embodiments, the time-domain averaging includes multiplying the frequency-domain averaged ASDs by one of a moving average and exponential decay function to forget past snapshots and offer good channel tracking performance in fast fading conditions. In some embodiments, the process also includes, prior to resampling the average ASD, frequency-shifting the average ASD so that a DC component of the average ASD is located in a center of a spectrum of the average ASD. In some embodiments, resampling the average ASD includes interpolating the average ASD using at least one of linear, polynomial and spline interpolation. In some embodiments, complex valued ASD data is interpolated using one of cartesian or polar coordinates. In some embodiments, the method also includes multiplying the resampled average ASD by a windowing function prior to determining the IFFT. In some embodiments, the method further includes frequency-shifting the average ASD to an initial state, so that a DC component is located at a first IFFT entry point prior to determining the IFFT. In some embodiments, the method also includes complex-conjugating an output of the IFFT to model an effect of an uplink channel covariance matrix transpose operation. In some embodiments, a first N entries from an output of the IFFT are retained, the first N entries corresponding to the frequency-transposed channel estimate, with remaining entries of the IFFT output corresponding to an initial zero padding being discarded. In some embodiments, the ASD is based at least in part on multiple uplink physical channels. In some embodiments, determining the average ASD includes determining an ASD based at least in part on uplink eigenvectors. In some embodiments, the uplink eigenvectors are uplink passive intermodulation, PIM, eigenvectors. In some embodiments, the frequency-transposed downlink channel estimate is used to reduce the downlink power in the direction of external PIM sources.

Having described the general process flow of arrangements of the disclosure and having provided examples of hardware and software arrangements for implementing the processes and functions of the disclosure, the sections below provide details and examples of arrangements for a channel reciprocity transform for multiple frequency beamforming.

In a multiple frequency system, the spatial behavior seen by the antenna array (i.e., directions of arrival and departure) is similar for the different frequencies. Therefore, the \hat{R}_{DL_f2} downlink covariance matrix can be estimated from the \hat{R}_{UL_f1} uplink covariance matrix, by applying a matrix transpose operation combined with an electrical spacing transform T_{λ}(·):

$${\hat{R}}_{DL \_ f 2} = {T}_{λ} ( {\hat{R}}_{UL \_ f 1}^{T} ) \qquad ( 1 )$$

In some embodiments, a channel estimation method enables an implicit computation of equation (1) at a moderate processing cost. Two versions of the algorithm are developed for a system with N antennas per polarization.

### Method 1: Using the Uplink Data Streams

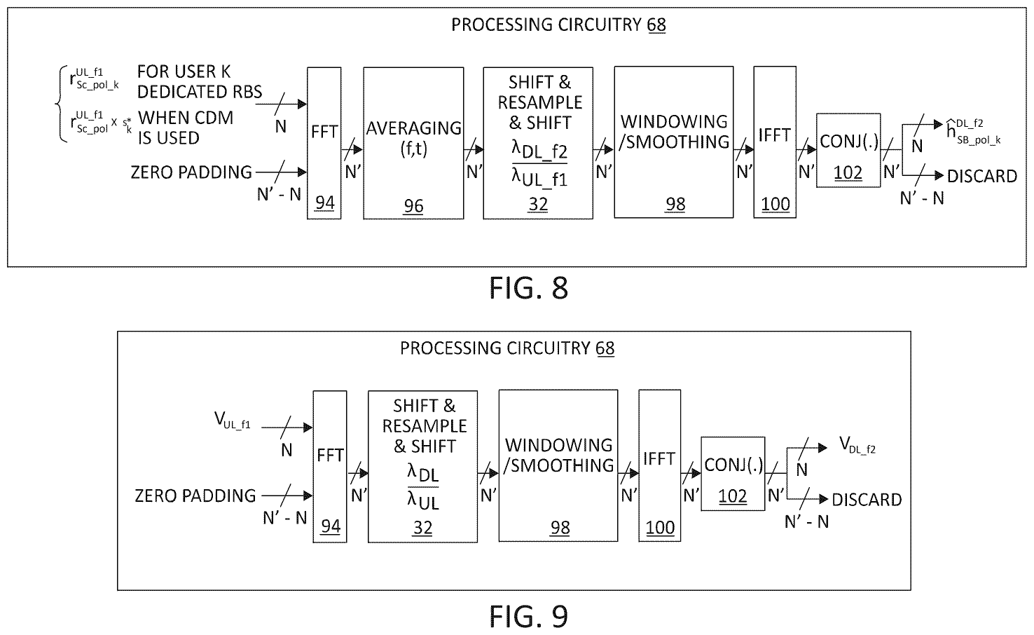

Referring to the example block diagram of FIG. 8, the uplink received vector r_{sc,pol}^{UL_f1}∈ [symbol] ^{N×1} for uplink sub-carrier sc and polarization pol is processed by a spatial DFT (shown in FIG. 8 as FFT unit 94) to produce the Angular Spectral Density (ASD). Some additional zeros may be padded at the input of the FFT unit 94 such that N′>N to ensure a high ASD resolution. The elements of FIG. 8 may be implemented by the processing circuitry 68 including the resampling unit 32.

This process may be repeated over multiple sub-carriers for each of the K users, using the user's dedicated Resource Blocks (RB's) from one or more predetermined uplink sub-bands. Multiple uplink channels may be used for this processing such as the PUCCH, PUSCH, SRS and DMRS.

In the case of Code Division Multiplexed (CDM) resource blocks, as in the SRS physical channel for example, it may be preferable to multiply the r_{sc,pol}^{UL_f1} vector by the complex-conjugate of the k^{th} user specific scrambling sequence sₖ prior to the spatial DFT (FFT 94) as shown in FIG. 8.

Then, some averaging may be applied by the averaging unit 96 to remove measurement noise from the multiple subcarriers and time snapshots. One or more of the following steps may be performed.
In a first step, the ASD from multiple sub-carriers belonging to the same OFDM symbol are averaged;
In a second step, the averaged frequency-domain ASDs from multiple time snapshots may be processed with a sliding window or an exponentially decaying forgetting factor. The time-domain moving average may be configured to forget snapshots that are distant into the past to provide better channel tracking performance in fast fading conditions.

The time and frequency averaged spectrum may then be resampled by resampling unit 32 at the λ_{DL_f2} wavelength for a specific downlink sub-band sb. This resampling process may be repeated for one or more downlink sub-bands. The ϕ azimuth angle associated with the ASD is expressed as follows for a horizontal uniform linear array:

$$ϕ = {sin}^{- 1} ( \frac{{λ}_{UL \_ f 1} \cdot {n}^{′}}{{d}_{y} \cdot {N}^{′}} ) \qquad ( 2 )$$

where:

$$\frac{{N}^{′}}{2} < {n}^{′} < ( \frac{N}{2} - 1 )$$

corresponds to the shifted FFT bin index;

$${λ}_{UL \_ f 1} = \frac{c}{{f}_{UL \_ f 1}}$$

is the wavelength at the uplink frequency, where c is the speed of light; and
d_{y} is the horizontal inter-element spacing in meter.

Before the resampling operation can be performed, the ASD is FFT shifted in the resampling unit 32 such that the DC tone is located in the center of the spectrum. This is done to respect the inverse sine function domain which goes from [−1; 1], thus avoiding the need for handling wrap-around effects during the resampling process.

The resampling is accomplished by interpolating the shifted ASD in the spatial frequency domain using either linear, polynomial, splines or other interpolation approaches. The process includes mapping the ASD from the original (ψ_{UL}, α_{UL}) points to the (ψ_{DL}, α_{DL}) points at the downlink frequency. The variables may be mapped as follows:

$${ψ}_{UL} = \frac{{λ}_{UL \_ f 1} \cdot {n}^{′}}{{d}_{y} \cdot {N}^{′}}$$

corresponds to the spatial frequency for the uplink channel;

$${ψ}_{DL} = \frac{{λ}_{UL \_ f 2} \cdot {n}^{′}}{{d}_{y} \cdot {N}^{′}}$$

corresponds to the spatial frequency for the downlink channel;
α_{UL} corresponds to the averaged and FFT shifted ASD produced by the signal processing chain; and
α_{DL} is the ASD at the downlink frequency to be identified.

The ASD interpolation may be performed using either cartesian (real/imaginary) or polar (magnitude/phase) coordinates. A second FFT shift may be applied by the resampling unit 32 to the resampled ASD to undo the FFT shift that was performed prior to the resampling function.

The next block in FIG. 8 is a windowing/smoothing function 98. The IFFT 100 expects the two ends of the resampled ASD (i.e., the first and the last tone) to be matching. Therefore, the resampled ASD may be multiplied point-by-point by a windowing function 98 prior to the IFFT 100. Alternatively, some other curve smoothing functions may be applied in a circular manner such as a moving average, a Savitzky-Golay smoothing filter, splines smoothing and other similar algorithms.

The IFFT 100 converts the ASD back into the antenna domain. The IFFT output is complex conjugated in complex conjugate unit 102 to capture the effect of the uplink channel covariance matrix transpose operation (\hat{R}_{UL_f1}^{T}). Finally, the first N entries from the IFFT output may be retained as they correspond to the frequency-transposed ĥ_{sb,pol,k}^{DL_f2}∈ [symbol] ^{N×1} channel estimate for downlink sub-band sb, polarization pol and user k. The extra entries corresponding to the initial zero padding may be discarded.

The ADL ĥ_{sb,pol,k} frequency-transposed channel estimate for downlink sub-band sb, polarization pol and user k can be used for various purposes:
a) SU-MIMO beamforming:
   The weights from the two polarizations) (±45° for user k in downlink sub-band sb may be combined in a single vector

$${\hat{h}}_{sb , k}^{DL \_ f 2} = {[ {( {\hat{h}}_{sb , + 45 ° , k}^{, DL \_ f 2} )}^{T} , {( {\hat{h}}_{sb , - 45 ° , k}^{DL \_ f 2} )}^{T} ]}^{T} ;$$

and/or
The combined vector is then normalized

$$\frac{{\hat{h}}_{sb , k}^{DL \_ f 2}}{‖ {\hat{h}}_{sb , k}^{DL \_ f 2} ‖} ;$$

and/or
The normalized vector may then serve as the precoding weights for user k;
b) MU-MIMO beamforming:
   The weights from the two polarizations) (±45° for user k in downlink sub-band sb may be combined in a single vector

$${\hat{h}}_{sb , k}^{DL \_ f 2} = {[ {( {\hat{h}}_{sb , + 45 ° , k}^{, DL \_ f 2} )}^{T} , {( {\hat{h}}_{sb , - 45 ° , k}^{DL \_ f 2} )}^{T} ]}^{T} ;$$

The combined weights for the K co-scheduled users may be aggregated in a ADL Ĥ_{sb}^{DL_f2} matrix for downlink sub-band sb as follows:

$${\hat{H}}_{sb}^{DL \_ f 2} = [ \begin{matrix}↑ & ⋯ & ↑ \\ {\hat{h}}_{sb , 0}^{DL \_ f 2} & ⋱ & {\hat{h}}_{sb , K - 1}^{DL \_ f 2} \\ ↓ & ⋯ & ↓\end{matrix} ] ;$$

The downlink MU-MIMO precoding weights may then be generated following a linear precoding method such as the minimum mean squared error (MMSE) or following a non-linear method like the Dirty Paper Coding.

For downlink PIM subspace estimation, it may be preferable to provide the algorithm with the wideband time-domain version of the signal and to average over a longer period such as one or more LTE/NR frames.

### Method 2: Using Uplink Eigenvectors

In some alternative embodiments, the algorithm may be provided with some V_{UL_f1} uplink eigenvectors at the uplink frequency as shown in the example block diagram of FIG. 9. The elements of FIG. 9 may be implemented in the network node 16, including the resampling unit 32. In this case, the “Moving Average” block 96 shown in FIG. 8 is removed from the signal processing chain as the eigenvectors have already been generated by such an averaging process. The algorithm then produces the U_{DL_f2} downlink eigenvectors at the downlink frequency.

In some downlink PIM subspace estimation embodiments, the algorithm is provided with time-domain or frequency-domain uplink PIM eigenvectors.

For simplicity, the algorithm has been described for one-dimensional uniform linear arrays. However, concepts presented herein may be extended to other array shapes such as uniform rectangular arrays.

Table 1 below summarizes the algorithms for one known method (Khalilsarai et al., “FDD Massive MIMO via UL-DL Channel Covariance Extrapolation and Active Channel Sparsification”, IEEE Transactions on Wireless Communications, vol. 18, no. 1, pp. 121-135, January 2018) and for the methods disclosed herein. To facilitate the comparison, the variable names from this work have been aligned to those from the known method.

The known method has an angle definition in the first rectangular block on the left in Table 1 which prevents the algorithm from working when the antenna inter-element spacing differs from 0.5λ. Note however that the known method may be fixed by redefining the angle definition as follows:

$${θ}_{fix} = {sin}^{- 1} ( \frac{[ - \frac{G}{2} : \frac{G}{2} - 1 ]}{G} \cdot \frac{λ}{d} )$$

Another difference between the known method (on the left in Table 1) and the presently disclosed method (on the right in Table 1) is that the present method performs the interpolation directly on the spatial frequency while the known method solves the problem in the angular domain.

TABLE 1

| Khalilsarai et al. | Proposed Method |
|---|---|
| 1: M is the number of antennas, d is the antenna inter- | 1: M is the number of antennas, d is the antenna inter- |
| element spacing in meter and κ is the spatial oversampling | element spacing in meter and κ is the spatial oversampling |
| factor | factor |
| 2: G = M × κ is the oversampled Fourier transform size | 2: G = M × κ is the oversampled Fourier transform size |
| 3: $Compute {θ}_{max} = {sin}^{- 1} ( \frac{{λ}_{ul}}{2 d} )$ | 3: Compute the UL and DL spatial frequency vectors ${ψ}_{ul / dl} = \frac{[ - \frac{O}{2} : \frac{O}{2} - 1 ]}{O} \times \frac{{λ}_{ul / dl}}{d}$ |
| 4: cₐᵢ is the first column of the uplink covariance matrix | 4: Pad G − M zeros to the first column cᵤₗ∈ [symbol] ^{^{M×1}} from |
| after projecting it onto T_{M}⁺, the Toeplitz, positive semi- | the UL covariance matrix (dominant eigenvector): cᵤₗ¹ = |
| definite cone (using convex programming) | \|cᵤₗ^{T},0\|_{1×(G-M)\|}\|^{T} |
| 5: Define the angular grid vector θ ∈ [symbol] ^{1×G} as: | 5: Compute the aᵤₗ ∈ [symbol] ^{G×1} UL angular spectral density |
| $θ = {sin}^{- 1} ( ( - 1 + \frac{2 \times [ 0 : G - 1 ]}{G} ) sin ( {θ}_{max} ) )$ | using a G-point PFT and fft-shift the resulting spectrum: aᵤₗ = f ftshift(f ft(c [symbol] , G)) |
| 6: Define G ∈ [symbol] ^{M×G} with columns g ∈ [symbol] ^{M×1} defined | 6: Perform linear interpolation using cartesian |
| $as : g = \frac{1}{\sqrt{M}} {e}^{j 2 π {\frac{d}{λ} [ 0 : M - 1 ]}^{T}} sin {θ}_{y}$ | coordinates (I/Q) to determine the DL angular spectral density a_{dl} as follows: |
| 7: Compute the optimal solution z [symbol] by solving the non- negative least-squares convex optimization problem | ${a}_{dl} [ n ] = ( {a}_{ul}^{0} ( {ψ}_{ul}^{1} - {ψ}_{dl} [ n ] ) + {a}_{ul}^{1} ( {ψ}_{dl} [ n ] - {ψ}_{ul}^{0} ) ) \times \frac{1}{{Δψ}_{ul}} , for$ |
| $defined as : {z}^{\text{?}} = {arg min}_{z ∈ {R}_{γ}^{C}} ‖ G z - {\hat{c}}_{ul} ‖$ | n ∈ [0:G − 1] |
| 8: The discretized ASF approximation is given by: \hat{γ}(dθ) = Σ [symbol] z [symbol] δ(θ − θᵢ) | 7: FFT-shift the DL angular spectral density a_{dl} and compute the G-point IFFT to produce the v_{dl} antenna-domain DL eigenvector: v_{dl} = if ft(f ftshift(a_{dl}), G) |
| 9: $Define α = \frac{{\int }_{dl}}{{\int }_{ul}} the UL - to - DL conversion factor$ | 8: Only retain the first M entries from the DL eigenvector: v_{dl} = v_{dl} [0:M −1] |
| 10: Compute ĉ_{dl}∈ [symbol] ^{M×1}the downlink covariance matrix first column estimate as follows: ${\hat{c}}_{dl} = {e}^{{jo [ 0 : M - 1 ]}^{T}} π \frac{\text{?}}{\text{?}} \hat{γ}$ | 9: $Normalize the DL eigenvector ( optional ) : {v}_{dl} = \frac{{v}_{dl}}{‖ {v}_{dl} ‖}$ |
| 11: The DL covariance matrix is given by the [symbol] Toeplitz | 10: Complex-conjugate the DL eigenvector: v_{dl} = [symbol] {v_{dl}} − |
| completion: Ĉ_{dl} = [symbol] (ĉ_{dl}) | [symbol] {v_{dl}} |
| | 11: If needed, identify other UL eigenvectors using a Gram- Schmidt orthogonalization procedure for other columns from the UL covariance matrix and repeat steps 4 to 10 |

[symbol]

indicates data missing or illegible when filed

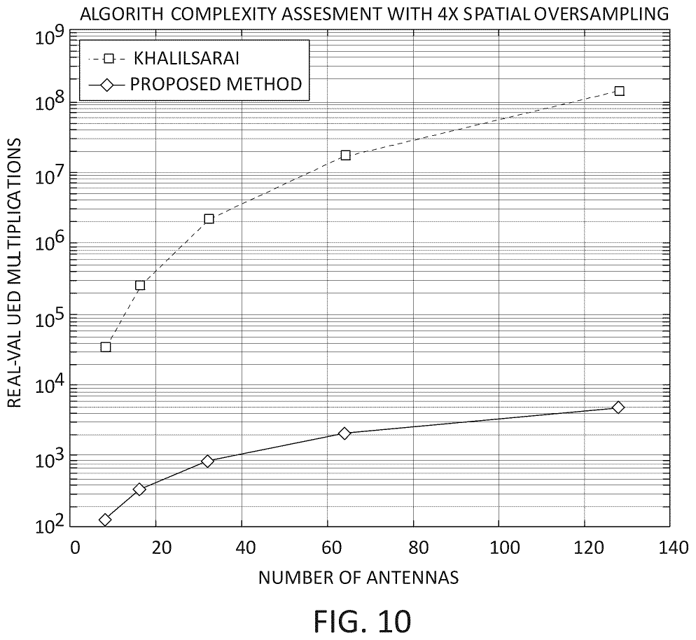

FIG. 10 compares the number of real-valued multiplications that are required to implement the two frequency resampling methods, sweeping the number of antennas. More specifically, only the following steps are compared to isolate the portion of the algorithms which handle the frequency translation aspect. Referring to Table 1:
1) Step 10 on the left (the known method), and ignoring the multiplications arising from steps 4, 7, 8 and 11 on the left;
2) Steps 6 and 7 on the right (the disclosed method). The number of real-valued multiplications required to compute a G-length complex-valued IFFT is taken from a known reference.

FIG. 10 is a graphical example demonstrating the implementation cost advantage of the disclosed method over the known method. Two orders of magnitude separate the two methods even with the smallest number of antennas (i.e., 16 antennas) that is considered in the plot, and the difference keeps growing with an increasing number of antennas.

Also the disclosed method achieves accuracy at a much lower implementation cost as compared to known methods.

The disclosed methods may be implemented in edge or in cloud computing resources and/or may be implemented in an pen-RAN digital unit (O-DU) or in an Open-RAN radio unit (O-RU).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
CA Carrier Aggregation
CDM Code Division Multiplexing
CSI-RS Channel State Information Reference Signal
DFT Discrete Fourier Transform
DL Downlink
DMRS Demodulation Reference Signal
FDD Frequency Division Duplex
FFT Fast Fourier Transform
IFFT Inverse Fast Fourier Transform
LTE Long-Term Evolution
MIMO Multiple-Input Multiple-Output
MU Multi-User
NR New Radio
OFDM Orthogonal Frequency-Division Multiplexing
PIM Passive Inter-Modulation
PUCCH Physical Uplink Control Channel
PUSCH Physical Uplink Shared Channel
RB Resource Block
SBEM Spatial Basis Expansion Model
SRS Sounding Reference Signal
SU Single-User
UCI Uplink Control Information
UE User Equipment
UL Uplink
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a wireless device, WD, the method comprising:
determining an average angular spectral density, ASD, based at least in part on a Fast Fourier transform, FFT, of an uplink received vector for each of multiple subcarriers from at least one antenna polarization;
resampling the average ASD at a wavelength for a subcarrier of the multiple subcarriers in a downlink sub-band; and
determining a frequency-transposed channel estimate for the downlink sub-band based at least in part on an inverse Fast Fourier transform, IFFT, of the resampled average ASD; and
beamforming a signal to the WD in the downlink sub-band using the determined frequency-transposed channel estimate.

2. The method of claim 1, further comprising adding zeros to an input to the FFT to increase resolution of the average ASD.

3. The method of claim 1, wherein determining the average ASD includes frequency-domain averaging ASDs for multiple subcarriers that belong to a same orthogonal frequency division multiplexed, OFDM, symbol.

4. The method of claim 1, wherein determining the average ASD includes time-domain averaging a frequency-domain averaged ASD.

5. The method of claim 4, wherein the time-domain averaging includes multiplying the frequency-domain averaged ASDs by one of a moving average and exponential decay function to forget past snapshots and offer good channel tracking performance in fast fading conditions.

6. The method of claim 1, further comprising, prior to resampling the average ASD, frequency-shifting the average ASD so that a DC component of the average ASD is located in a center of a spectrum of the average ASD.

7. The method of claim 1, wherein resampling the average ASD includes interpolating the average ASD using at least one of linear, polynomial and spline interpolation.

8. The method of claim 1, wherein complex valued ASD data is interpolated using one of cartesian or polar coordinates.

9. The method of claim 1, further comprising multiplying the resampled average ASD by a windowing function prior to determining the IFFT.

10. The method of claim 1, further comprising frequency-shifting the average ASD to an initial state, so that a DC component is located at a first IFFT entry point prior to determining the IFFT.

11. The method of claim 1, further comprising complex-conjugating an output of the IFFT to model an effect of an uplink channel covariance matrix transpose operation.

12. The method of claim 1, wherein a first N entries from an output of the IFFT are retained, the first N entries corresponding to the frequency-transposed channel estimate, with remaining entries of the IFFT output corresponding to an initial zero padding being discarded.

13. The method of claim 1, wherein the ASD is based at least in part on multiple uplink physical channels.

14. The method of claim 1, wherein determining the average ASD includes determining an ASD based at least in part on uplink eigenvectors.

15. The method of claim 14, wherein the uplink eigenvectors are uplink passive intermodulation, PIM, eigenvectors.

16. The method of claim 1, wherein the frequency-transposed downlink channel estimate is used to reduce the downlink power in the direction of external PIM sources.

17. A network node configured to communicate with a wireless device, WD, the network node comprising processing circuitry configured to:
determine an average angular spectral density, ASD, based at least in part on a fast Fourier transform, FFT, of an uplink received vector for each of multiple subcarriers from at least one antenna polarization;
resample the average ASD at a wavelength for a subcarrier of the multiple subcarriers in a downlink sub-band;
determine a frequency-transposed channel estimate for the downlink sub-band based at least in part on an inverse fast Fourier transform, IFFT, of the resampled average ASD; and
beamform a signal to the WD in the downlink sub-band using the determined frequency-transposed channel estimate.

18-32. (canceled)

33. A non-transitory computer-readable medium storing thereon a computer program comprising instructions which, when executed on at least one processor, cause the at least one processor to carry out the method of claim 1.
